(19) United States
(12) Patent Application Publication
(10) Pub. No.: US 2003/0019897 A1
(43) Pub. Date: Jan. 30, 2003

(54) Method for separating a brittle material

(75) Inventors: Ta-Ko Chuang, Taichung (TW); Sakae Tanaka, Taoyuan Hsien (TW)

Correspondence Address: Richard P. Berg, Esq., c/o LADAS & PARRY, 5670 Wilshire Boulevard, Suite 2100, Los Angeles, CA, 90036-5679, US

(73) Assignee: Hannstar Display Corp.

(21) Appl. No.: 10/053,158

(22) Filed: Jan. 15, 2002

(30) Foreign Application Priority Data
Jul. 27, 2001 (TW) 90118411

(51) Int. Cl. B26F 3/00

(52) U.S. Cl. 225/2; 225/103

(57) ABSTRACT

A method for separating a brittle material is provided. First, a brittle material, having a first surface and a second surface, is provided. Then, a reference line is scribed on a predetermined position of the first surface of the brittle material along a first direction by laser. Finally, a soft-breaker is provided, and the soft-breaker separates the brittle material along a second direction by strikes the second surface of the brittle material. Thus, the quality of the brittle material, separated based on the method of this invention, is maintained at a certain level so that the processes subsequent to the separation process are reduced.

### BACKGROUND OF THE INVENTION

1. Field of the invention

The invention relates to a method for separating a brittle material; in particular, the invention relates to a material separation method that can maintain the quality of the material after separation and reduce subsequent processes.

2. Description of the related art

A conventional method for separating a brittle material is shown in FIG. 1a and FIG. 1b. Here, the brittle material is represented by a laminated glass 10. The laminated glass 10 comprises a first substrate 11, a second substrate 12, and a seal 13 disposed between the first substrate 11 and the second substrate 12. To separate the laminated glass 10, a reference line 22 is scribed firstly on the first substrate 11 by an unillustrated diamond blade or an unillustrated hard metal wheel. The hard metal wheel may be made of tungsten carbide. Then, the laminated glass 10 is turned upside down and is placed on a support stage 21. A break bar 23 strikes the second substrate 12 along the reference line 22 so as to separate the first substrate 11. Subsequently, another reference line is scribed on the second substrate 12 by the unillustrated diamond blade or the unillustrated hard metal wheel. The laminated glass 10 is turned upside down again, and the break bar 23 strikes the first substrate 11 along the second reference line (not labeled) so as to separate the second substrate 12. Thus, the laminated glass 10 is separated.

The disadvantages of the conventional method are described as follows.

1. Since the brittle material is scribed and struck by the hard material, many chips and particles are produced.

2. Micro-cracks, generated on the separated brittle material, can not be avoided.

3. After the separation process, cleaning and grinding are necessary.

4. The method is not adapted for separating a thinner brittle material.

### SUMMARY OF THE INVENTION

In order to address the disadvantages of the aforementioned separation method, the invention provides a brittle material separation method that can maintain the quality of the material after separation and reduce subsequent processes.

Accordingly, the invention provides a method for separating a brittle material. The method as disclosed in this invention comprises the following steps. First, a brittle material, having a first surface and a second surface, is provided. Then, a reference line is scribed on a predetermined position of the first surface of the brittle material along a first direction by laser. Finally, a soft-breaker is provided, and the soft-breaker separates the brittle material along a second direction by rolling on the second surface of the brittle material.

Furthermore, the first direction and the second direction are opposite.

In a preferred embodiment, the soft-breaker comprises a metal wire and a rolling wheel, and the metal wire of the soft-breaker striking the brittle material by the rolling wheel rotating on the metal wire. The metal wire is coated with a plastic material.

In a preferred embodiment, the soft-breaker is a breaking bar with a curved surface, and the curved surface is coated with a plastic material.

In a preferred embodiment, the method further comprises a step of generating an initial crack on the first surface of the brittle material prior to the scribing step. The initial crack is generated by laser or a hard material.

Furthermore, the brittle material is a liquid crystal display panel.

In a preferred embodiment, a method for separating a laminated glass is provided. The method comprises the following steps. A laminated glass, having a first substrate and a second substrate, is provided. A first reference line is scribed on a predetermined position of the first substrate of the laminated glass by laser. A soft-breaker is provided, and the soft-breaker rolls on the second substrate of the laminated glass so as to separate the first substrate of the laminated glass. A second reference line is scribed on a predetermined position of the second substrate of the laminated glass by laser, and the soft breaker rolls on the first substrate of the laminated glass so as to separate the second substrate of the laminated glass.

### BRIEF DESCRIPTION OF THE DRAWINGS

The invention is hereinafter described in detail with reference to the accompanying drawings in which:

FIG. 1a is a schematic view depicting a conventional method for separating a brittle material;

FIG. 1b is another schematic view depicting a conventional method for separating a brittle material;

FIGS. 2a-2c are schematic views depicting a first embodiment of a method for separating a brittle material as disclosed in this invention;

FIG. 3a is a schematic view depicting a first embodiment of a soft-breaker as disclosed in this invention;

FIG. 3b is a schematic view depicting a second embodiment of a soft-breaker as disclosed in this invention;

FIGS. 4a-4d are schematic views depicting a second embodiment of a method for separating a brittle material as disclosed in this invention;

FIG. 5a and FIG. 5b are schematic views depicting the soft-breaker of the first embodiment applied to a laminated material;

FIG. 5c is a schematic view depicting the soft-breaker of the second embodiment applied to a laminated material; and

FIG. 6 is a schematic view depicting a liquid crystal display panel separated by the method of this invention.

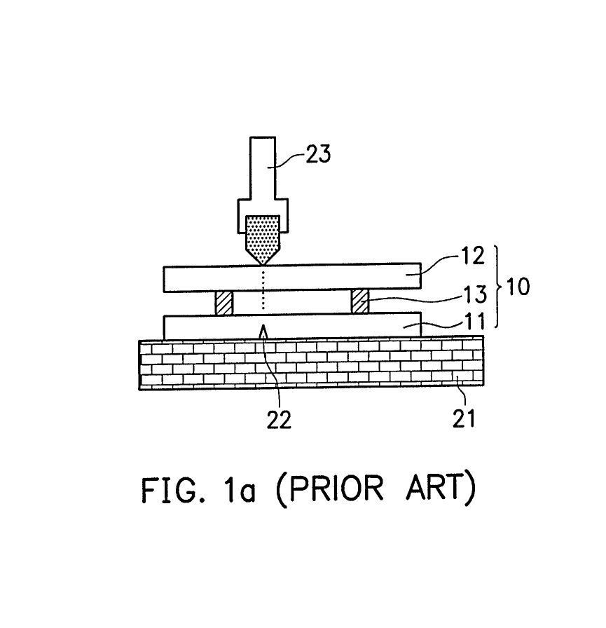

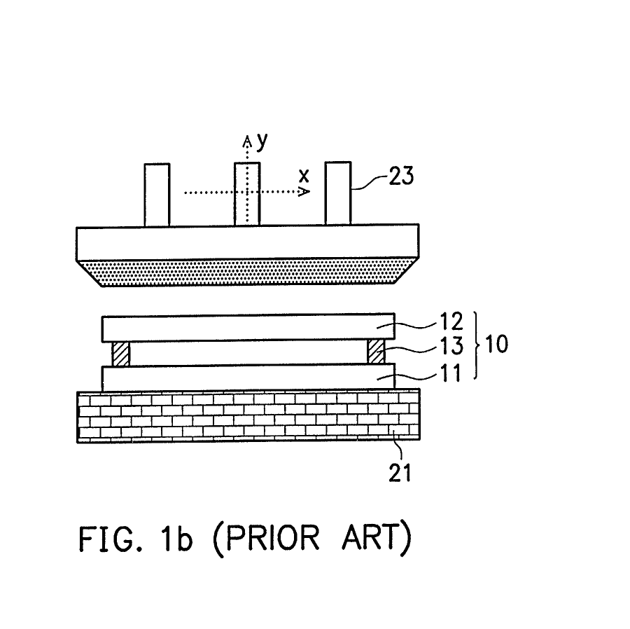

### DETAILED DESCRIPTION OF THE INVENTION

First embodiment

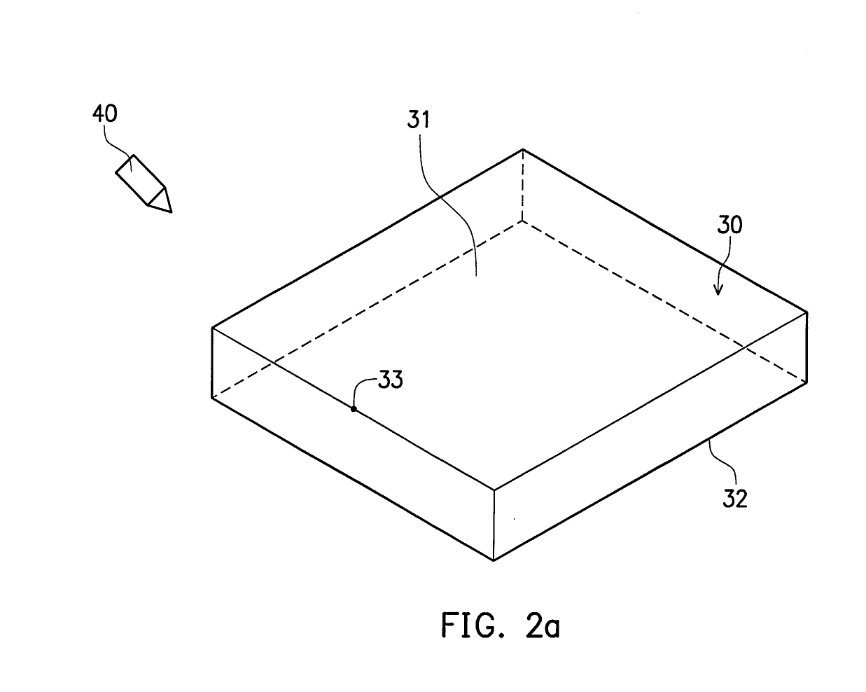

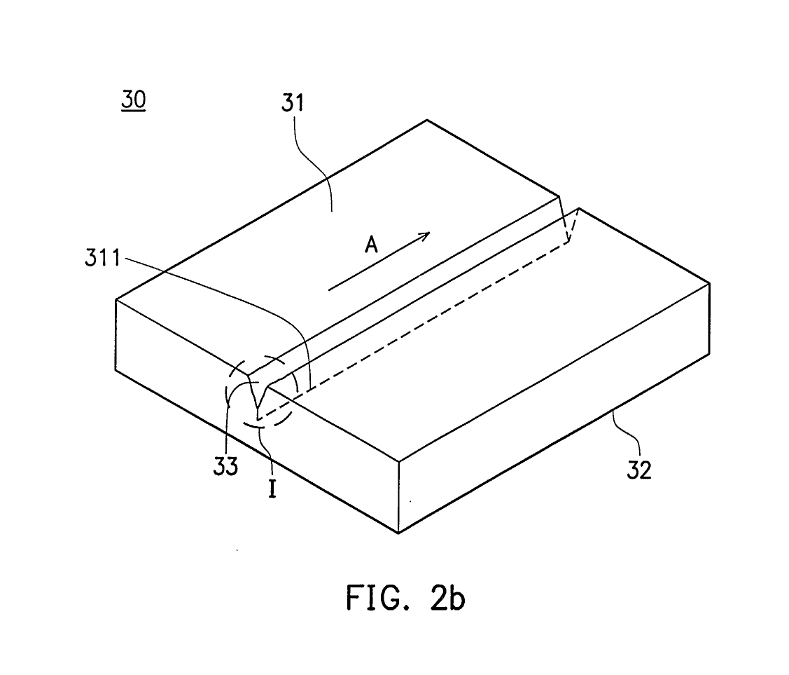

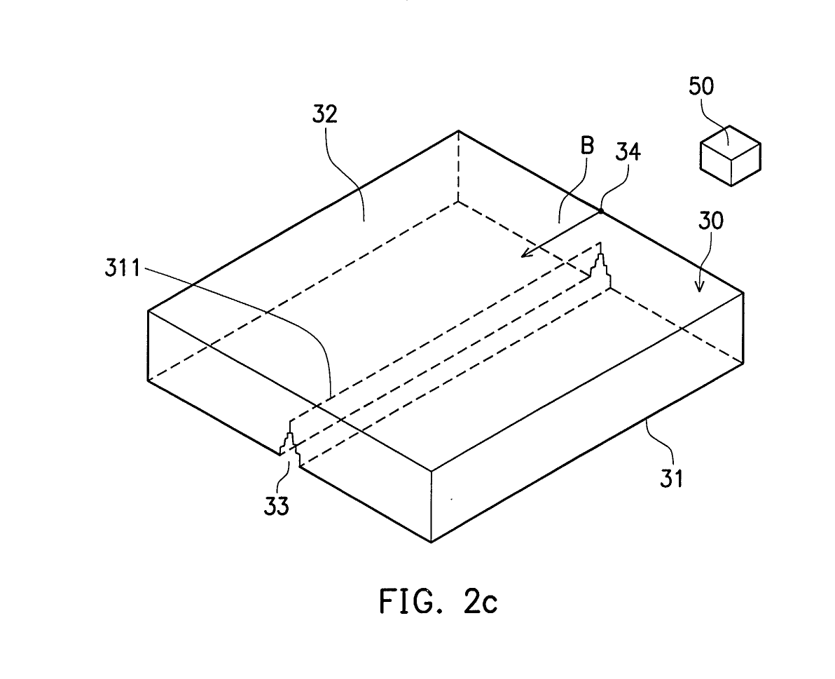

A method, as disclosed in a first embodiment of this invention, for separating a brittle material is shown in FIG. 2a, FIG. 2b and FIG. 2c. First, a brittle material 30, having a first surface 31 and a second surface 32, is provided, as shown in FIG. 2a. Then, an initial crack 33 is generated on the first surface 31 of the brittle material 30 by laser or a hard material (not shown). A reference line 311 is scribed on the first surface 31 of the brittle material 30 along a first direction A by a laser 40, as shown in FIG. 2b. A soft-breaker 50 is provided, and it separates the brittle material 30 along a second direction B from an initial striking point 34 by striking the second surface 32 of the brittle material 30 after flipping, as shown in FIG. 2c.

It is noted that the creation of the initial crack 33 is different from the creation of the reference line 311 so that an area I around the initial crack 33 is much less uniform, as shown in FIG. 2b. To prevent the non-uniformity of the area I from affecting the quality of the subsequent separation process, the first direction A and the second direction B may be opposite. That is, the initial crack 33 and the initial striking point 34 are located at the opposite side of the brittle material 30.

The soft-breaker 50, as disclosed in this invention, is not directly in contact with the brittle material 30 when it strikes. The soft-breaker 50 is in contact with the brittle material 30 via a softer material.

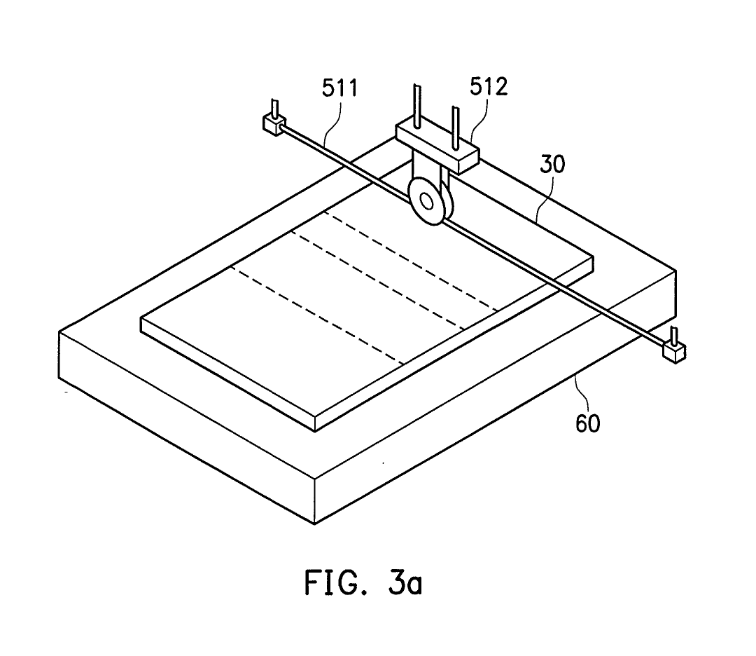

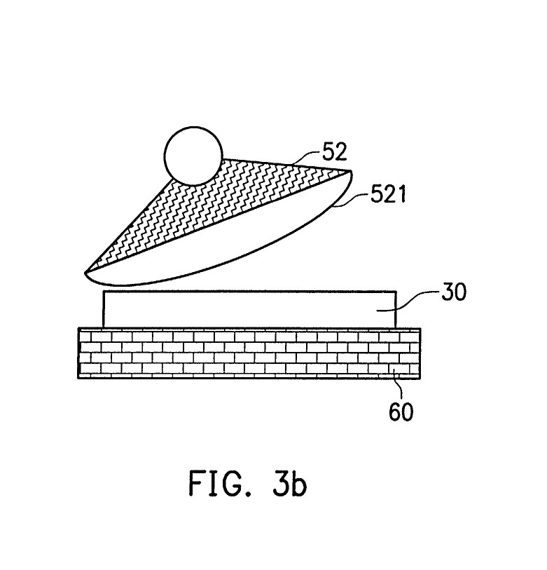

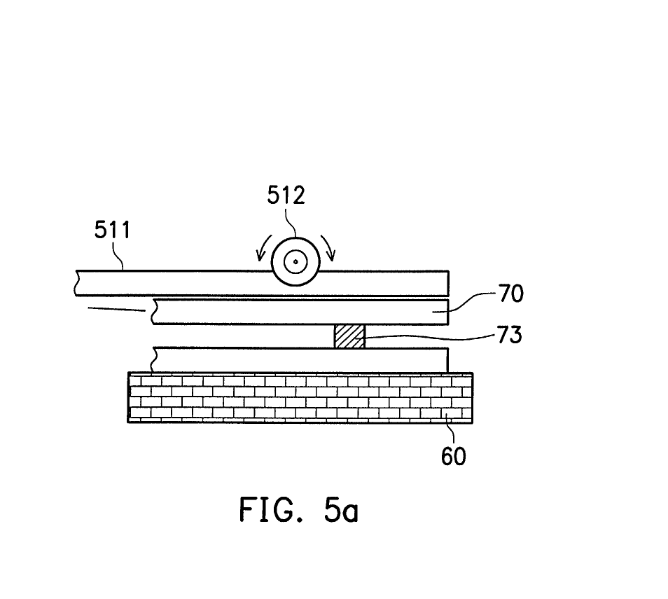

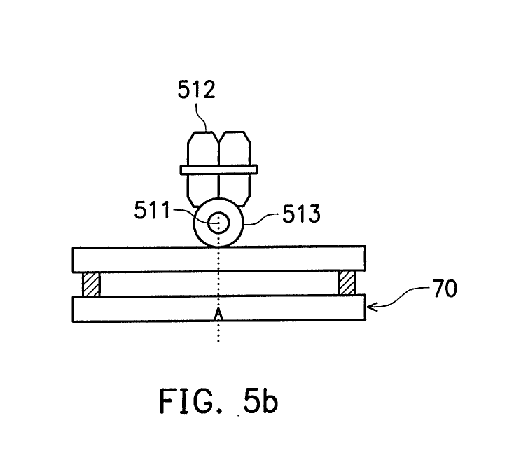

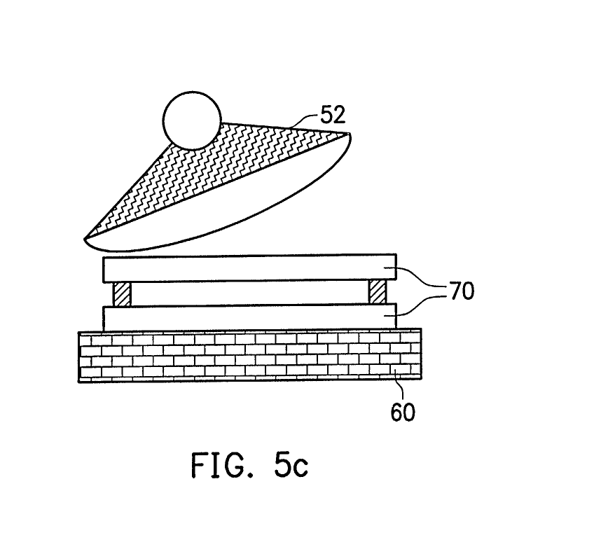

For example, referring to FIG. 3a, the soft-breaker 50 comprises a metal wire 511 and a rolling wheel 512, and the metal wire 511 is coated with a plastic material 513, as shown in FIG. 5b. The plastic material 513, disposed around the metal wire 511 of the soft-breaker 50, strikes the brittle material 30 by the rolling wheel 512 rotating on the metal wire 511. Since the soft-breaker 50 is in contact with the brittle material 30 via a plastic material 513, micro-cracks can be reduced significantly on the brittle material 30 after separation.

In addition, the metal wire may be replaced by a piano wire or another wire with elasticity and rigidity.

Referring to FIG. 3b, the soft-breaker 50′ may be a breaking bar 52 with a curved surface 521, wherein the curved surface 521 is coated with a plastic material. Since the soft-breaker 50 is in contact with the brittle material 30 via a plastic material, micro-cracks can be reduced significantly on the brittle material 30 after separation.

The method, as disclosed in this invention, attains the following advantages.

1. Since the brittle material is scribed and struck via the softer material, there are few chips, particles or micro-cracks generated after separation.

2. By means of the method of this invention, the edge quality of the separated brittle material is excellent, and its edge strength is enhanced.

3. Unlike the conventional method, cleaning and grinding are not necessary after separation so that subsequent processes can be reduced.

4. The method of this invention can be adapted for separating a thinner brittle material.

Second embodiment

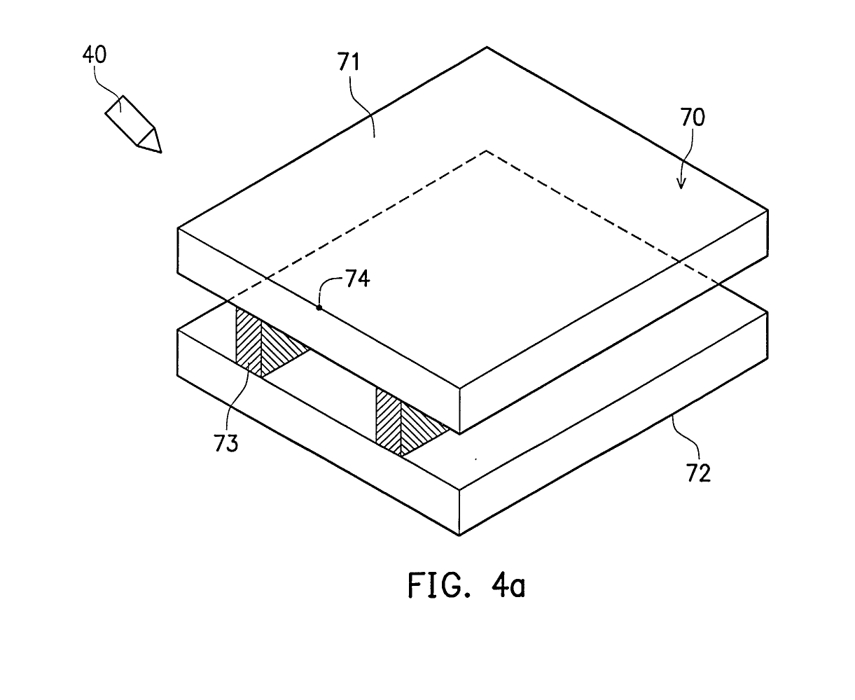

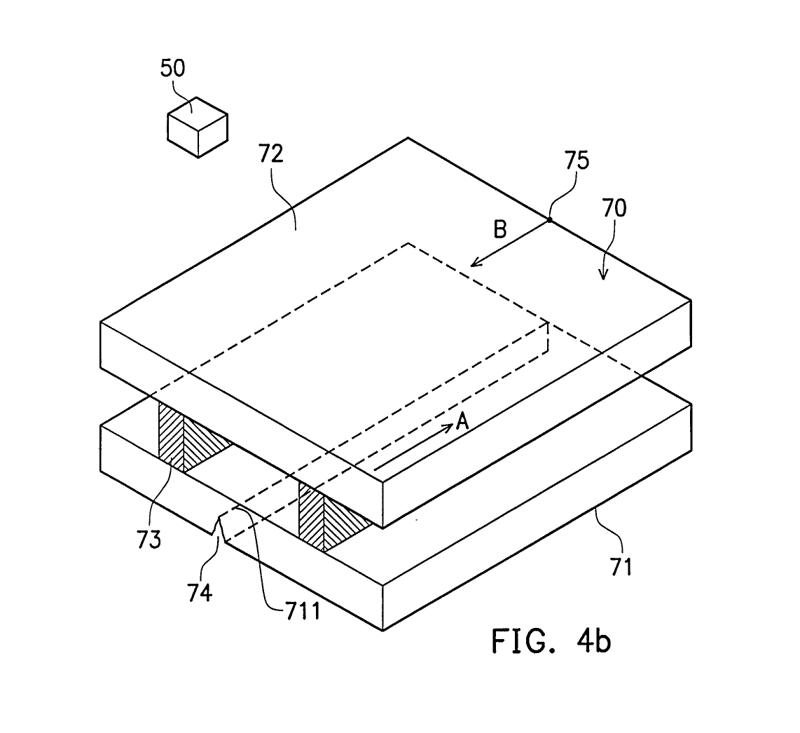

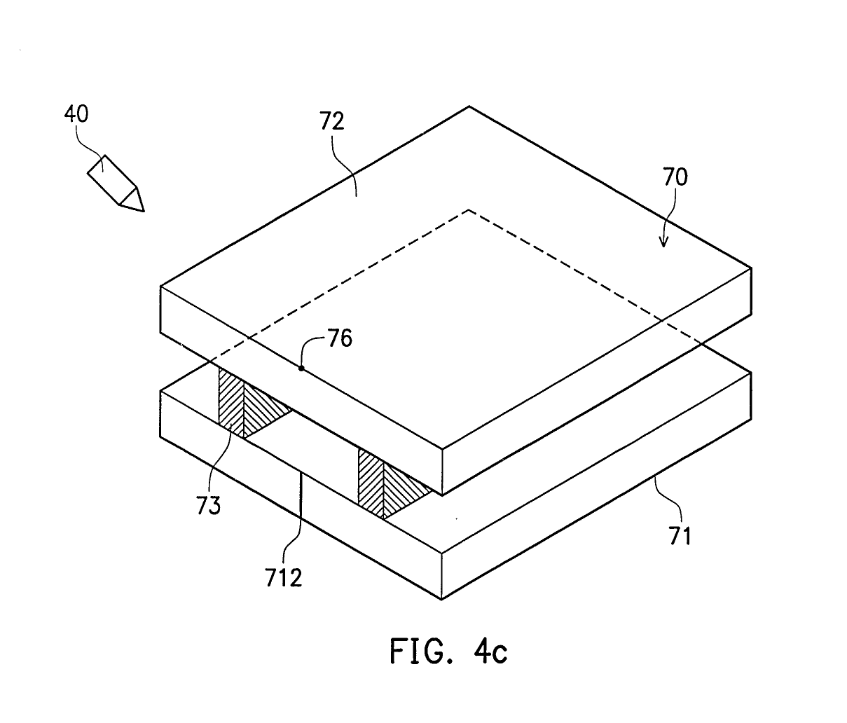

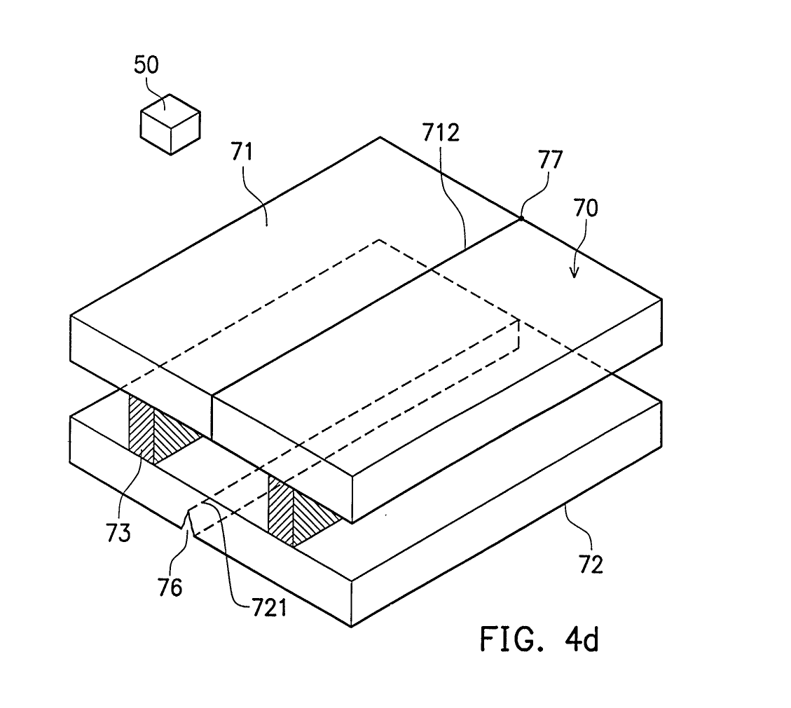

A method, as disclosed in a second embodiment of this invention, for separating a brittle material is shown in FIG. 4a, FIG. 4b, FIG. 4c and FIG. 4d. In this embodiment, a laminated glass 70, having a first substrate 71 and a second substrate 72, is used as the brittle material, as shown in FIG. 4a. A first reference line 711 is scribed on the first substrate 71 of the laminated glass 70 from a first initial crack 74 along a first direction A by a laser 40, as shown in FIG. 4b. A soft-breaker 50 strikes the second substrate 72 of the laminated glass 70 from an first initial striking point 75 to separate the first substrate 71 of the laminated glass 70. A cutting line 712 is generated on the first substrate 71, as shown in FIG. 4c. A second reference line 721 is scribed on the second substrate 72 of the laminated glass 70 from a second initial crack 76 along a second direction by a laser 40, as shown in FIG. 4d. The soft-breaker 50 strikes the first substrate 71 of the laminated glass 70 from an initial striking point 77 so as to separate the second substrate 72 of the laminated glass 70. Thus, the laminated glass 70 is separated.

FIG. 5a, FIG. 5b and FIG. 5c are schematic views depicting the soft-breaker 50 applied to a laminated glass 70.

The difference between the first embodiment and the second embodiment is that one more scribing/striking step is required in this embodiment because the laminated glass comprises two substrates.

Third embodiment

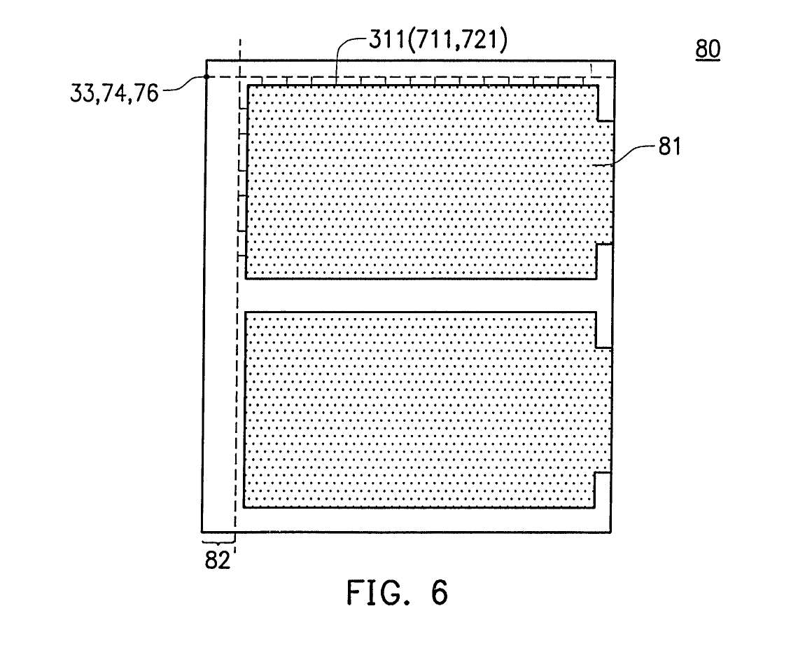

A method, as disclosed in a third embodiment of this invention, for separating a brittle material is shown in FIG. 6. In this embodiment, a liquid crystal display panel 80 is used as the separated material. The separation method of this embodiment is the same as the second embodiment, thus its description is omitted.

Referring to FIG. 6, the liquid crystal display panel 80 comprises an active area (display area) 81 and a dummy area (scraped area) 82.

The third embodiment teaches that the initial crack 33, 74, 76 and the reference line 311, 711, 721 should be located at the dummy area when the separated material comprises an active area and a scraped area. Thus, the active area can be protected from damage.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. A method for separating a brittle material comprising:
(a) providing a brittle material having a first surface and a second surface;
(b) scribing a reference line on a predetermined position of the first surface of the brittle material along a first direction by laser;
(c) providing a soft-breaker; and
(d) the soft-breaker separating the brittle material along a second direction by striking the second surface of the brittle material.

2. The method as claimed in claim 1, wherein the first direction and the second direction are opposite.

3. The method as claimed in claim 1, wherein the soft-breaker comprises a metal wire and a rolling wheel, and the metal wire of the soft-breaker strikes the brittle material by the rolling wheel rotating on the metal wire.

4. The method as claimed in claim 3, wherein the metal wire is coated with a plastic material.

5. The method as claimed in claim 1, wherein the soft-breaker is a breaking bar with a curved surface, and the curved surface is coated with a plastic material.

6. The method as claimed in claim 1, further comprising:
generating an initial crack on the first surface of the brittle material prior to step (b).

7. The method as claimed in claim 6, wherein the initial crack is generated by laser.

8. The method as claimed in claim 6, wherein the initial crack is generated by a hard material.

9. The method as claimed in claim 1, wherein the brittle material is a liquid crystal display panel.

10. A method for separating a laminated glass comprising:
(a) providing a laminated glass having a first substrate and a second substrate;
(b) scribing a first reference line on a predetermined position of the first substrate of the laminated glass by laser;
(c) providing a soft-breaker;
(d) the soft-breaker striking the second substrate of the laminated glass so as to separate the first substrate of the laminated glass;
(e) scribing a second reference line on a predetermined position of the second substrate of the laminated glass by laser; and
is (f) the soft-breaker striking the first substrate of the laminated glass so as to separate the second substrate of the laminated glass.

11. The method as claimed in claim 10, wherein the scribing direction of the first substrate and the breaking direction of the second substrate are opposite.

12. The method as claimed in claim 10, wherein the scribing direction of the second substrate and the breaking direction of the first substrate are opposite.

13. The method as claimed in claim 10, wherein the soft-breaker comprises a metal wire and a rolling wheel, and the metal wire of the soft-breaker strikes the laminated glass by the rolling wheel rotating on the metal wire.

14. The method as claimed in claim 13, wherein the metal wire is coated with a plastic material.

15. The method as claimed in claim 10, wherein the soft-breaker is a breaking bar with a curved surface, and the curved surface is coated with a plastic material.

16. The method as claimed in claim 10, further comprising:
generating a first initial crack on the first substrate of the brittle material prior to step (b); and
generating a second initial crack on the second substrate of the brittle material prior to step (e).

17. The method as claimed in claim 16, wherein the first initial crack and second initial crack are generated by laser.

18. The method as claimed in claim 16, wherein the first initial crack and second initial crack are generated by a hard material.

19. The method as claimed in claim 10, wherein the laminated glass is a liquid crystal display panel.
